(19) United States
(12) Patent Application Publication
(10) Pub. No.: US 2025/0314081 A1
(43) Pub. Date: Oct. 9, 2025

(54) DRYWALL PAN ILLUMINATION ASSEMBLY

(71) Applicant: Derick Kaydon Lang, Sioux Falls, SD (US)

(72) Inventor: Derick Kaydon Lang, Sioux Falls, SD (US)

(21) Appl. No.: 18/629,297

(22) Filed: Apr. 8, 2024

(51) Int. Cl. E04F 21/02; F21V 33/00

(52) U.S. Cl. CPC E04F 21/02; F21V 33/00

(57) ABSTRACT

A drywall pan illumination assembly includes an illumination system and a coupler secured to the illumination system. The coupler is magnetic to releasably couple the illumination system to an exterior surface of a drywall pan, such that the illumination system illuminates an area adjacent to a drywall pan.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to drywall pans and drywall accessories and more particularly pertains to a new drywall pan illumination assembly for illuminating an area adjacent to a drywall pan, such as darker corners of a room or any other work area with insufficient lighting, to provide greater visibility to a drywall worker.

### (2) Description of Related Art including information disclosed under 37 CFR 1.97 and 1.98

The prior art relates to drywall pans and accessories. The prior art, as best understood, does not disclose a drywall pan illumination assembly that includes an illumination system and a coupler secured to the illumination system. In the present case, the coupler is magnetic to releasably couple the illumination system to an exterior surface of a drywall pan. This will allow a user to easily remove the illumination system from the drywall pan to allow cleaning of the drywall pan without damaging the illumination system.

### BRIEF SUMMARY OF THE INVENTION

An embodiment of the disclosure meets the needs presented above in a drywall pan illumination assembly generally comprising an illumination system and a coupler secured to the illumination system. The coupler is magnetic to releasably couple the illumination system to an exterior surface of a drywall pan, such that the illumination system illuminates an area adjacent to the drywall pan.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a drywall pan illumination assembly according to an embodiment of the disclosure.

FIG. 2 is a bottom perspective view of an embodiment of the disclosure.

FIG. 3 is a front view of an embodiment of the disclosure.

FIG. 4 is a rear view of an embodiment of the disclosure.

FIG. 5 is a side view of an embodiment of the disclosure.

FIG. 6 is a perspective view of an embodiment of the disclosure in use.

FIG. 7 is a perspective view of an embodiment of the disclosure in use.

FIG. 8 is a cross-sectional view of a portion of an embodiment of the disclosure in use.

FIG. 9 shows a schematic diagram of components of an embodiment of the disclosure.

### DETAILED DESCRIPTION OF THE INVENTION

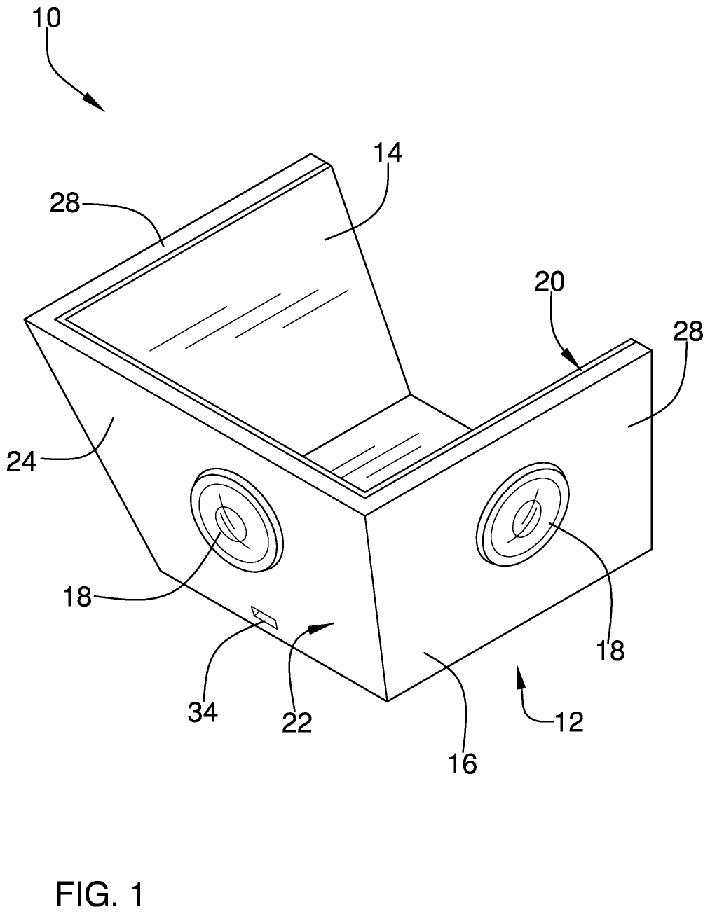

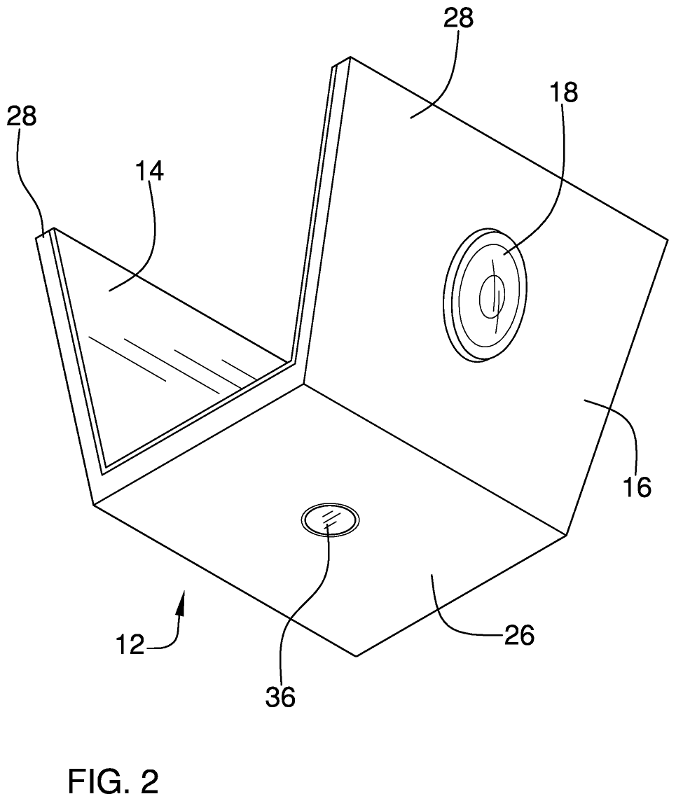

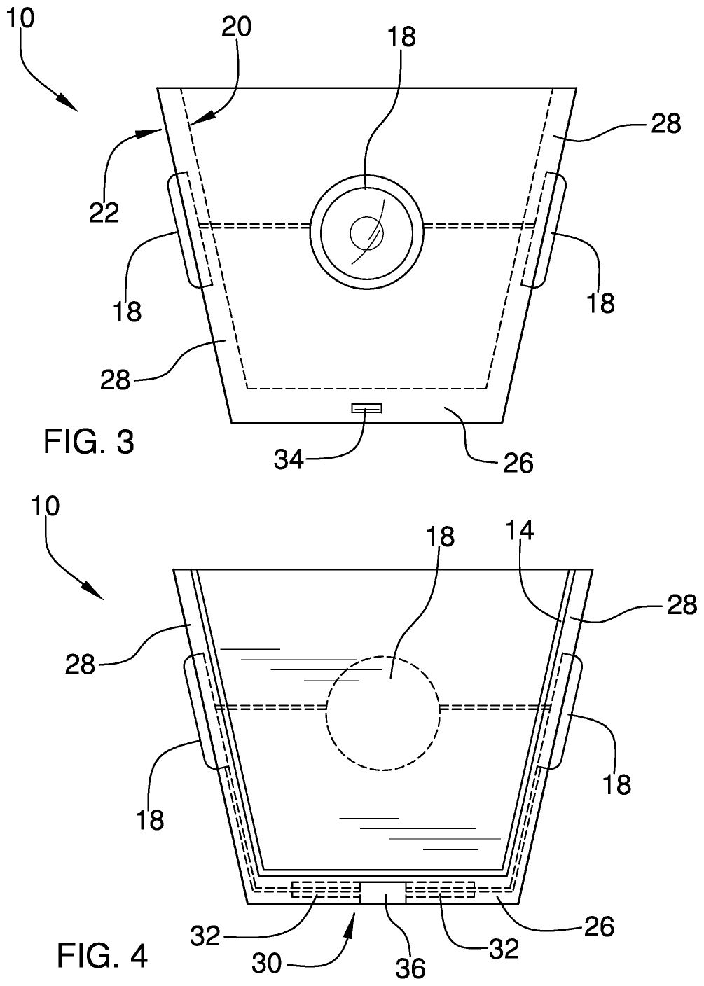

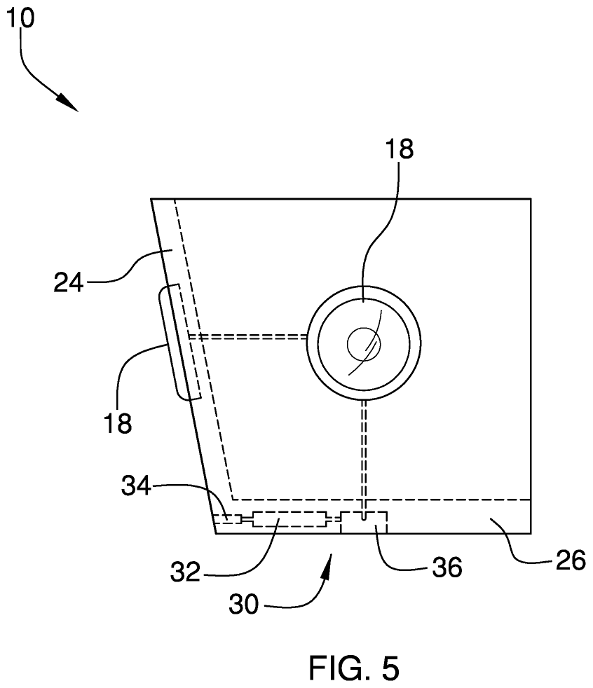

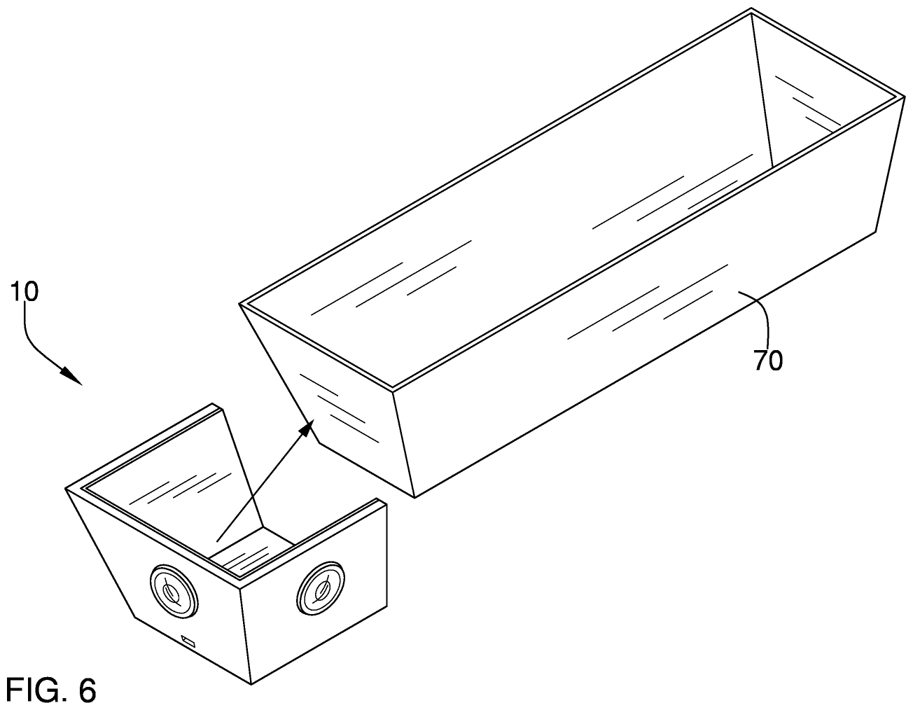

With reference now to the drawings, and in particular to FIGS. 1 through 9 thereof, a new drywall pan illumination assembly embodying the principles and concepts of an embodiment of the disclosure and generally designated by the reference numeral 10 will be described.

As best illustrated in FIGS. 1 through 5, the drywall pan illumination assembly 10 generally comprises an illumination system 12 and a coupler 14 secured to the illumination system 12. The coupler 14 is magnetic to releasably couple the illumination system 12 to an exterior surface of a drywall pan, such that the illumination system 12 illuminates an area adjacent to the drywall pan. The drywall pan illumination assembly 10 is to be used with a drywall pan, also known as a mud pan, drywall mud pan, or trowel pan, to provide a drywall worker with a portable source of illumination for work areas, such as dark rooms or areas with insufficient lighting. The drywall worker can position illumination assembly 10 to illuminate work areas adjacent to the drywall pan.

The illumination system 12 includes a saddle 16 attached to the coupler 14 and a plurality of light emitters 18 mounted on the saddle 16. The saddle 16 has an inner surface 20 and an outer surface 22. The inner surface 20 has a shape corresponding to a portion of an exterior surface of a drywall pan. The coupler 14 is positioned on the inner surface 20. The light emitters 18 are positioned on the outer surface 22. The coupler 14 is in the form of a magnetic liner that covers the inner surface 20 of the saddle 16, though in one possible embodiment the coupler 14 could be a smaller magnetic body, or possibly divided into multiple magnetic bodies. The saddle 16 itself could be made of metal or plastic or a combination thereof that is durable and lightweight so that the drywall pan illumination assembly 10 can withstand wear and tear without adding much weight to a drywall pan. In one possible embodiment, the light emitters 18 are LED lights.

The saddle 16 includes a plurality of panels attached together and angled with respect to each other, which panels include a front panel 24, a bottom panel 26 transverse to the front panel 24, and two lateral panels 28 transverse to the front panel 24 and the bottom panel 26. The coupler 14 is positioned on each of the panels 24, 26, 28, which produces a strong connection to the drywall pan 70. In the embodiment shown in the figures, each of the front panel 24 and the two lateral panels 28 have one of the light emitters 18 mounted thereon. However, other arrangements of the light emitters are within the scope of the disclosure. For example, only two of the panels 24, 26, 28 could have one of the light emitters 18 mounted thereon, or more than one of the light emitters 18 could be mounted on one or more of the panels 24, 26, 28.

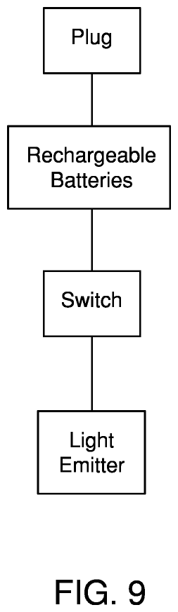

The illumination system 12 includes a power unit 30 mounted to the saddle 16 and electrically coupled to the light emitters 18. The power unit 30 includes rechargeable batteries 32 and a plug 34 electrically coupled to the rechargeable batteries 32. The plug 34 is a USB plug, though other plugs or receptacles for other power connections are within the scope of the disclosure. The power unit 30 includes a switch 36 electrically coupled to the light emitters 18 to turn the light emitters 18 on and off. These components are shown schematically in FIG. 9.

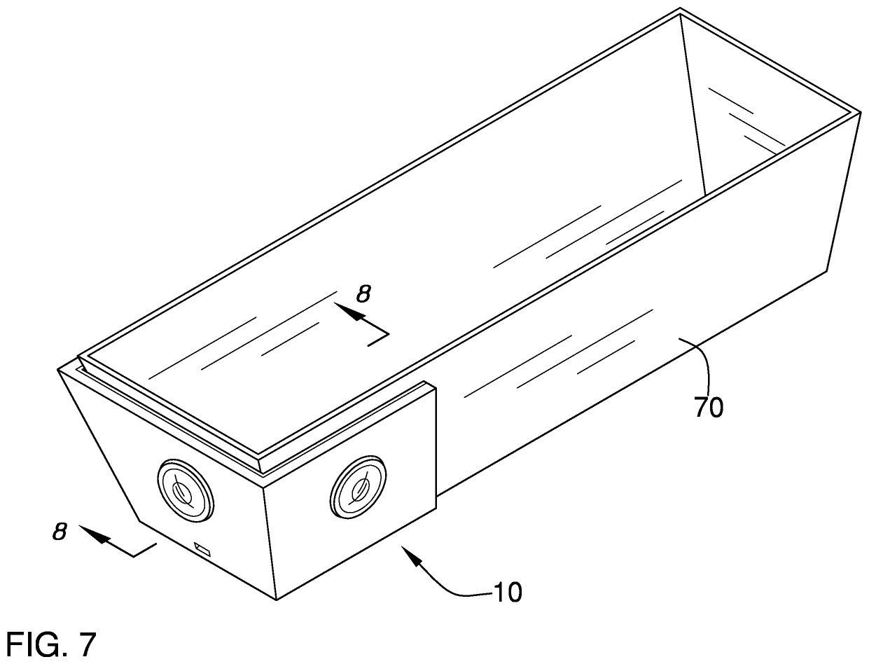

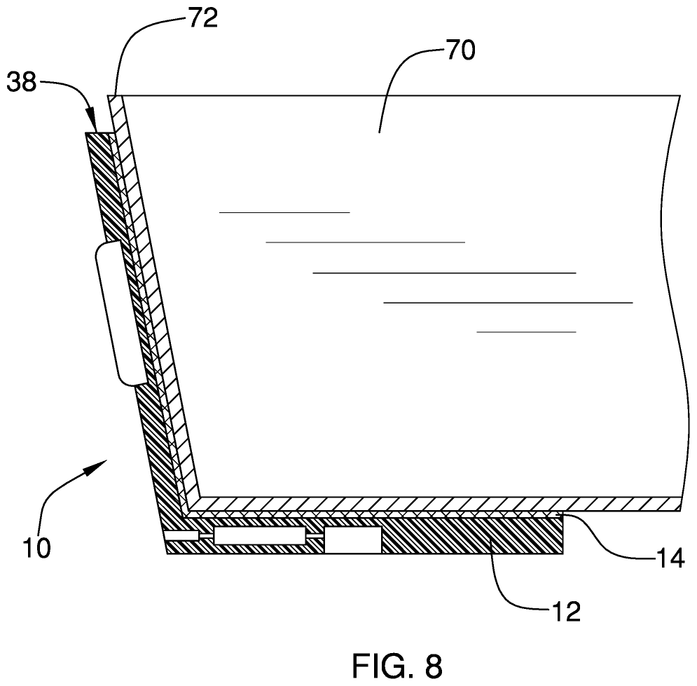

FIGS. 6 through 8 show how the illumination system 12 can be releasably coupled to a drywall pan 70 used for containing drywall mud or similar material. The illumination system 12 is releasably coupled to an end portion of the drywall pan 70, which allows the user to hold the center of the drywall pan 70 from below without obstructing any of the light emitters 18. The drywall pan 70 is in the form of a trough, and the saddle 16 is also in the form of an open-ended trough such that the end portion of the drywall pan 70 and the saddle 16 fit together in a nested relationship. The drywall pan 70 shown in FIGS. 6 through 8 has an essentially trapezoidal cross-sectional shape, so the saddle 16 also has an essentially trapezoidal cross-sectional shape. In addition, the end wall of the drywall pan 70 is angled outwardly, so the front panel 24 is also angled outwardly. In one possible embodiment, the saddle 16 could be designed to have an essentially square or rectangular shape to fit drywall pans having such a shape. As shown in FIGS. 7 and 8, the drywall pan 70 has a lip 72 and the saddle 16 has an upper edge 38. The saddle 16 is designed such that when the saddle 16 is releasably coupled to the drywall pan 70, the upper edge 38 of the saddle 16 is positioned below and a distance from the lip 72. This positioning of the saddle 16 keeps the saddle 16 out of the way when a user is scooping drywall material out of the drywall pan 70. In one possible embodiment, the drywall pan illumination assembly 10 is combined with the drywall pan 70 to form a drywall pan system.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drywall pan illumination assembly comprising:
an illumination system; and
a coupler secured to said illumination system, said coupler being magnetic to releasably couple said illumination system to an exterior surface of a drywall pan such that said illumination system illuminates an area adjacent to a drywall pan.

2. The drywall pan illumination assembly of claim 1, wherein said illumination system comprises a saddle attached to said coupler and a plurality of light emitters mounted on said saddle.

3. The drywall pan illumination assembly of claim 2, wherein said saddle has an inner surface and an outer surface, said inner surface has a shape corresponding to a portion of an exterior surface of a drywall pan, and said coupler is disposed on said inner surface.

4. The drywall pan illumination assembly of claim 3, wherein said light emitters are disposed on said outer surface.

5. The drywall pan illumination assembly of claim 4, wherein said saddle comprises a plurality of panels attached together and angled with respect to each other.

6. The drywall pan illumination assembly of claim 5, wherein at least two of said panels have one of said light emitters mounted thereon.

7. The drywall pan illumination assembly of claim 5, wherein said coupler is disposed on each of said panels.

8. The drywall pan illumination assembly of claim 5, wherein said panels comprise a front panel, a bottom panel transverse to said front panel, and two lateral panels transverse to said front panel and said bottom panel.

9. The drywall pan illumination assembly of claim 8, wherein each of said front panel and said two lateral panels have one of said light emitters mounted thereon.

10. The drywall pan illumination assembly of claim 3, wherein said coupler comprises a magnetic liner covering said inner surface.

11. The drywall pan illumination assembly of claim 2, wherein said illumination system comprises a power unit mounted to said saddle and electrically coupled to said light emitters.

12. The drywall pan illumination assembly of claim 11, wherein said power unit comprises rechargeable batteries and a plug electrically coupled to said rechargeable batteries.

13. The drywall pan illumination assembly of claim 12, wherein said plug comprises a USB plug.

14. The drywall pan illumination assembly of claim 11, wherein said power unit comprises a switch electrically coupled to said light emitters to turn said light emitters on and off.

15. The drywall pan illumination assembly of claim 2, wherein said light emitters comprise LED lights.

15. The drywall pan illumination assembly of claim 1, wherein:
said illumination system comprises a saddle attached to said coupler and a plurality of light emitters mounted on said saddle;
said saddle has an inner surface and an outer surface, said inner surface has a shape corresponding to a portion of an exterior surface of a drywall pan, said coupler is disposed on said inner surface, said illumination system comprises a plurality of light emitters, said light emitters are disposed on said outer surface;
said saddle comprises a plurality of panels attached together and angled with respect to each other, at least two of said panels have one of said light emitters mounted thereon, said panels comprise a front panel, a bottom panel transverse to said front panel, and two lateral panels transverse to said front panel and said bottom panel, said coupler is disposed on each of said panels, each of said front panel and said two lateral panels have one of said light emitters mounted thereon, said coupler comprises a magnetic liner covering said inner surface;
said illumination system comprises a power unit mounted to said saddle and electrically coupled to said light emitters, said power unit comprises rechargeable batteries, said power unit comprises a plug electrically coupled to said rechargeable batteries, said power unit comprises a switch electrically coupled to said light emitters to turn said light emitters on and off, said plug comprises a USB plug; and
said light emitters comprise LED lights.

17. A drywall pan system comprising:
a drywall pan;
an illumination system; and
a coupler secured to said illumination system, said coupler being magnetic to releasably couple said illumination system to an exterior surface of said drywall pan such that said illumination system illuminates an area adjacent to said drywall pan.

18. The drywall pan system of claim 17, wherein said illumination system comprises a saddle attached to said coupler and a plurality of light emitters mounted on said saddle.

19. The drywall pan system of claim 18, wherein said drywall pan has a lip and said saddle has an upper edge disposed below and a distance from said lip.

20. The drywall pan system of claim 18, wherein said saddle is releasably coupled to an end portion of said drywall pan.
